(19) United States
(12) Patent Application Publication
(10) Pub. No.: US 2008/0215361 A1
(43) Pub. Date: Sep. 4, 2008

(54) System and Method for Leveraging Health Care at a Point of Sale

(76) Inventors: Paul G. Nunnari, Lansdale, PA (US); Anthony D. Milinowicz, Hamilton Square, NJ (US); Stephen A. Zollo, Ocean City, NJ (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/885,142

(22) PCT Filed: Sep. 21, 2005
(86) PCT No.: PCT/US05/33888

§ 371 Date: Aug. 27, 2007

(30) Foreign Application Priority Data
Sep. 22, 2004 (US) 10946947

(51) Int. Cl. G06Q 30/00; G06Q 50/00; G06Q 10/00

(52) U.S. Cl. 705/2; 705/14; 705/7

(57) ABSTRACT

A novel pharmacy messaging system, method and computer program product that leverages healthcare by providing functionality enabling the generation of targeted messages for enhancing the patient's experience while waiting for their prescription to be filled. The invention addresses directly the issue of leveraging healthcare by optimizing the customer time spent waiting to have their prescriptions filled, and particularly, by driving “foot-traffic” to the local pharmacy and successfully transforming patient wait time into a potential revenue generating opportunity for companion products. The pharmacy messaging system delivers targeted messages to patients based on their prescription information and one or more of their demographic, healthcare payor, claims, and past purchase history.

### FIELD OF THE INVENTION

The present invention related generally to the field of healthcare, and more particularly to a novel system and business method for leveraging health care to address the needs of all stakeholders in a retail environment.

### BACKGROUND OF THE INVENTION

Many pharmacies that fill patients prescriptions for medicine and related doctor prescribed healthcare and medical supply products are located in and operated within larger retail outlets. It is the case however, that most patients' needs are not fully met in the retail setting. This is exemplified by a typical prescription filling process scenario whereby a medical doctor writes a prescription for the patient, and the patient visits the pharmacy to have the prescription filled. The pharmacist receives the handwritten prescription which if often partially legible, requiring the pharmacist to makes a clarifying phone call, e.g., 30% of the time. Upon clarification by the prescribing doctor, the fulfillment is documented. Typically, any interaction or formulary violations associated with the filled prescription causes more work for the pharmacist. Moreover, in most cases, the pharmacist is often too busy to provide appropriate counseling to the patient/consumer and no compliance follow-up is performed.

Most inconvenient for the patient is the fact that throughout the prescription fulfillment process at the retail outlet, there is significant patient wait time. For instance, statistics reveal an average wait from the time of prescription drop off to the time of picking up the filled prescription at the local pharmacy is between 25 to 30 minutes. While most pharmacies that fill patients prescriptions for doctor prescribed healthcare and medical supply products are located and operated within larger retail outlets or “drug stores” (e.g., Walgreen, CVS, Eckerd, Rite-Aid, etc.,) having a “front-end” including non-prescription merchandise such as over-the-counter (OTC) health-care merchandise, e.g., such as OTC medications, health and beauty aids, and other items such as convenience foods and drinks, greeting cards and stationery items, it is often the case that most patients do not optimize their time within these retail outlets. The patient prescription fill wait time is typically idle (‘dead’) time and, oftentimes the patient may either wait and do nothing, shop for unneeded or unrelated merchandise, or even exit the store to shop and/or make item purchases at a nearby store and return later to pick up the filled prescription product. This is a loss situation for the retail pharmacy as potential customer revenue is lost for those patients that wait and do nothing, or exit the store to shop elsewhere.

Further, to the patient's detriment, proper patient counseling/instruction is typically never provided by the pharmacist and the patient may not fully understand the treatment. Questions the patient may have regarding use of the prescribed product often go unanswered and the patient typically must call the prescribing physician's office for clarification. All these factors contribute to the deterioration of any patient/pharmacy relationship that may have existed, as the patient experiences little or no customer satisfaction. This situation is exacerbated by the pharmacy's burden of processing ever increasing amounts of prescription orders, dispensing medications, and billing.

Furthermore, there currently exists a prescription drug persistence and compliance problem. That is, statistics reveal that that about 10% of the prescriptions written are never filled and about 25% of prescriptions that are indicated for renewal, are never renewed. Moreover, statistics reveal that about 50% of prescription drugs that are dispensed, are taken by patient's at sub-optimum dosages, e.g., reduced dosage, in contradiction to the prescribed dose. This may be attributable to the side effects that the patient experiences when taking the prescribed drug. These persistence and compliance issues tend to prolong the treatment duration and increase the cost of patient healthcare.

Efforts have been made to increase customer satisfaction by way of technological improvements. The advent and implementation of point-of-sale (POS) equipment and quick response programs improve efficiency and productivity in drugstores. Electronic POS scanners, which are linked to a computer network, read the universal product code (UPC) labels on products. This information, detailing exactly what shoppers are buying, is captured and stored in a database, where the retailer can study it. POS scanners also reduce labor costs and enhance price accuracy by eliminating the need to mark items individually. From the customer's perspective, scanners reduce checkout time and generate a receipt detailing the type and price of each item purchased. More recent innovations include central fulfillment and central procurement facilities, pharmacy workflow software, and automated dispensing equipment and picking systems can be tied into management information systems to enable pharmacists and technicians to order, pick, price, dispense, and bill for drugs more quickly and efficiently. Many pharmacies are now installing automated dispensing machines, giving pharmacists more time to work on drug utilization reviews.

U.S. Pat. No. 6,240,394 entitled METHOD AND APPARATUS FOR AUTOMATICALLY GENERATING ADVISORY INFORMATION FOR PHARMACY PATIENTS describes a system directed to generating targeted advisory messages to pharmacy patients based on the combination of various data including the National Drug Codes (NDC) of the prescription drug, and the patient's age, gender, new script or renewal and payor information. The advisory messages generated include all types of information to pharmacy patients including information about the prescribed product being dispensed, related products or procedures, promotional materials or discounts pertaining to the purchase of prescription products or other products. However, one disadvantage of the system described is that it is only based at the location of the pharmacy, provides only a single source of data capture, and generates the targeted message or promotion at the time of dispensing the prescription after the patient has waited.

It would be highly desirable to provide a system and method that would enhance the customer experience in having their prescriptions fulfilled and optimize the patient wait time by encouraging front-end product purchase for products related to the prescription being filled.

It would further be highly desirable to provide a system and method that would enhance the customer experience by enabling pharmacies to provide improved patient counseling leading to improved pharmacy/patient relationships and prescription drug persistence and compliance that will lead to improved health care outcomes.

It would further be highly desirable to provide a system and method that would optimize the retail outlet's revenue per patient/customer all the while optimizing the customer prescription wait time experience by providing promotions encouraging patient's purchase of related non-prescription products that enhance safety or increase efficacy of the prescription drugs that are being dispensed to them.

Given the case that number of prescriptions in the United States is rapidly increasing, e.g., about three billion prescriptions are written each year with the number expected to increase, it would be highly advantageous to leverage healthcare and facilitate a customer's adding to the market basket.

### SUMMARY OF THE INVENTION

It is an object of the present invention is to provide a system, method and computer program product that leverages healthcare by providing functionality enabling the generation of targeted messages for enhancing the patient's experience while waiting for their prescription to be filled. The invention addresses directly the issue of leveraging healthcare by optimizing the customer time spent waiting to have their prescriptions filled, and particularly, by driving “foot-traffic” within the pharmacy and successfully transforming patient wait time (currently ‘dead’ time) into a potential revenue generating opportunity for companion products.

Thus, according to one aspect of the invention there is provided a system, method and computer program product for generating targeted messages for customers, the system comprising: a retail business entity having a pharmacy adapted for receiving and filling customer prescriptions for products, the retail business entity further adapted to selling over the counter (OTC) products to said customers,

a means for receiving information about a customer's prescription at the time of filling, and associating a complementary OTC product for potential use by said customers; and,

a means responsive to said received information for a generating customer targeted message promoting use and/or purchase of said associated complementary OTC product available for purchase at the retail business entity.

Advantageously, the customer targeted message is generated at the point of sale for said patient and includes a promotion discount coupon for the complementary OTC product which is redeemable at the retail business entity while the customer prescription is being filled. However, it is within the scope of the invention to additionally offer coupons, for other products that may be intended to occupy the customer's time while waiting for their prescription to be filled, such as beverages, magazines, food items such as snacks, etc., besides the complementary non-prescription products.

Such targeted messages are generated for receipt by the patient at the time a prescription is handed to the pharmacist further includes one or more of: managed care formulary compliance; instant consumer rebates/tier leveling rebates; prescription drug to OTC availability; companion sales (couponing); new product launches/line extensions; and, persistence and compliance/disease management programs.

According to another aspect of the invention, there is provided a novel method for providing goods and services to a customer through a retail business entity having a pharmacy adapted for receiving and filling customer prescriptions, the method comprising steps of:

supplying products for potential purchase by customers; and,

generating one or more targeted messages deliverable to customers while filling prescriptions at said pharmacy for encouraging customers to purchase the products at said retail business.

Advantageously, the targeted message for the customer is generated at the point of sale and includes a discount coupon for encouraging customer purchase of complementary OTC products. In one aspect, the complementary OTC products include companion products that ameliorate potential side effects associated with customer's taking of a prescription product. In another aspect, the complementary OTC products include companion products that enhance efficacy of a customer's taking of a prescription product. The discount coupons for the complementary OTC products and other products intended to occupy the customer's time while waiting are redeemable at the retail business entity while the customer prescriptions are being filled. The goods and merchandise that may be sold appeal to a broad range of patient/customers thus enabling high overall store margins. Most importantly, encouraging purchase of complementary products that reduce the side effects and providing patient education and prescriptive drug information will lead to increased persistence and compliance, thus, improving healthcare outcomes and reducing patient costs.

Additionally, provided is a business process that captures data at multiple points in the prescription creation to fulfillment process and generates coupons, promotions, or messages accordingly that are deliverable to patients via fax, email, or print at the POS at the time of prescription dropoff.

Furthermore, the supermarkets and drugstores having pharmacies in addition to front-end merchandise further leverage the functionality of electronic POS and data storage/data mining systems by tracking each customer's purchases and compiling the data, which may be used to analyze product sales according to a variety of criteria: e.g., size, color, and store. Thus, retailers may better assess the effectiveness of their promotions and base their buying decisions on facts rather than conjecture, identifying the best-selling mix of merchandise. Thus, the breadth of a retail store's or third party product brand line may be leveraged by capturing the synergies from closer linkage between the back and front-ends of the retailer's business.

### BRIEF DESCRIPTION OF THE DRAWINGS

The objects, features and advantages of the present invention will become apparent to one skilled in the art, in view of the following detailed description taken in combination with the attached drawings, in which:

FIG. 1 illustrates conceptually a pharmacy messaging system 10 according to the present invention;

FIG. 2 illustrates a hardware architecture supporting the pharmacy messaging system 10 of the present invention;

FIGS. 3(a)-3(b) illustrate the data processing 100 performed by the system 10 of the present invention; and,

FIG. 4 illustrates the mapping table engine for retrieving one or more companion OTC products that are associated with the prescribed drug indicated for the safety and/or enhanced efficacy.

### DETAILED DESCRIPTION OF THE PREFERRED EMBODIMENTS

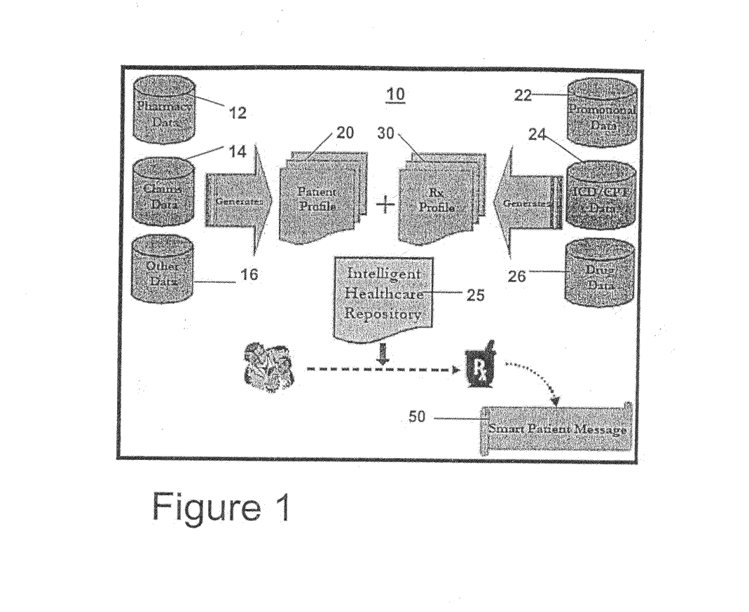

FIG. 1 illustrates a block diagram of a Pharmacy Messaging System 10 according to the present invention. The Pharmacy Messaging System 10 of the present invention relates to the use, in retail pharmacies, of an intelligent health repository along with other consumer data sets to analyze purchasing patterns and other longitudinal healthcare data to automatically generate targeted patient messages at the point-of-sale (POS). While various systems have been used to generate script related advisory information, this service would be the first to drive “foot-traffic” to the local pharmacy and successfully transform patient wait time (currently ‘dead’ time) into a potential revenue generating opportunity for companion products.

Particularly, as shown in the conceptual block diagram of FIG. 1, the system 10 provides for an intelligent healthcare repository 25 that receives and stores patient profile data 20 and prescription profile data 30 for patients and, includes a data engine adapted for generating smart patient messages 50, i.e., targeted messages to patients based on their demographic, healthcare payor, claims, and past purchase history. Particularly as shown in FIG. 1, the present invention includes databases for storing patient related data including past pharmacy purchase history data 12, claims data 14 and other data 16 including, but not limited to: payor information, renewal status, contraindications, amount of co-payment, and formulary status; and, additionally includes a data processing engine for receiving these types of patient data, singularly or in combination, at the POS to generate a patient profile 20. Similarly, the present invention includes databases for storing patient related data including pharmacy promotions data 22, International Classification of Disease/Current Procedural Terminology (ICD/CPT) data 24 and prescription drug related data 26 which may be input, either singularly or in combination, to a transaction processing engine at or remotely located from the POS to generate a prescription profile 30. The combination of these types of profiles is used to generate a smart patient message 50. Unlike the generation of coupons reflecting purchases currently generated by printers at retail/supermarket check out counters after products have been purchased, the Pharmacy Messaging system 10 of the present invention delivers to the patient the a smart patient message 50 at the time the prescription is being filled. The data processing engine of the Pharmacy Messaging System 10 responds to one or more of the various types of data maintained, to generate a targeted promotion/coupon for one or more complementary “front-end” OTC companion products, at the time their prescription is being filled, to encourage their redemption while the customer is waiting for their prescription to be filled. Such targeted messages are generated for receipt by the patient after the pharmacist enters the drug information from the prescription at the POS. Besides the ability to generate companion sales coupons, informative messages that may be additionally generated for the patient's benefit include one or more of: managed care formulary compliance; instant consumer rebates/tier leveling rebates; Rx to OTC availability; new product launches/line extensions; and, persistence and compliance/disease management programs.

In a preferred embodiment, the complementary OTC products include companion products that either: 1) ameliorate or eliminate potential side effects associated with customer's taking of the prescription product; or, 2) enhance efficacy of a customer's taking of a prescription product.

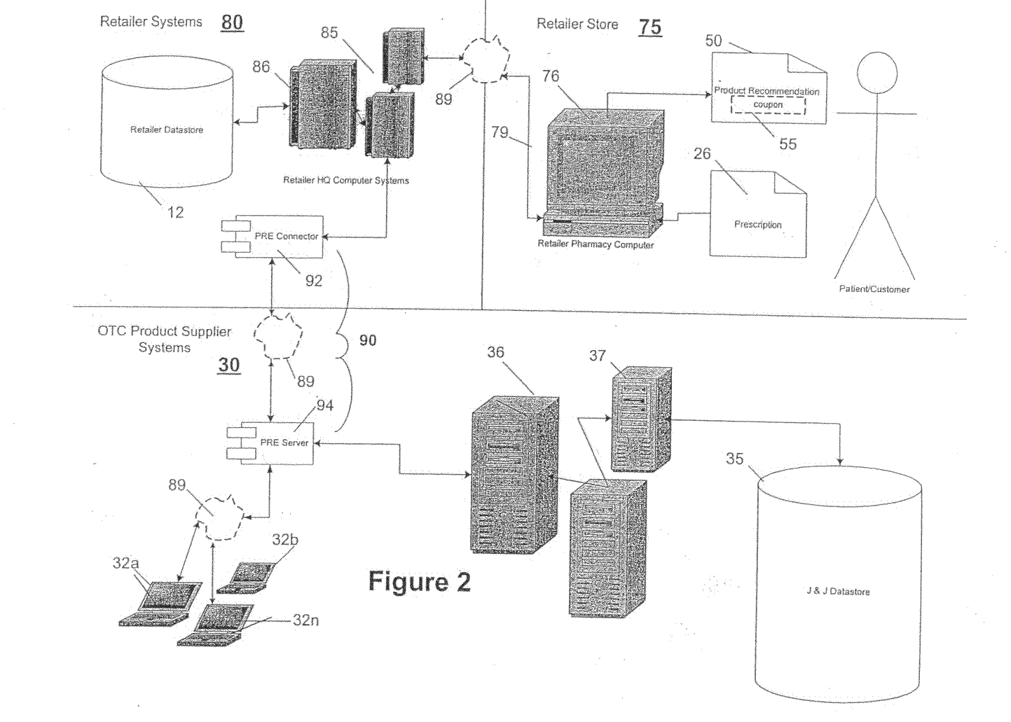

One embodiment of the hardware architecture 100 corresponding to the Pharmacy Messaging System of FIG. 1 is now shown in FIG. 2. In FIG. 2, there is depicted a retail store 75 including a retail pharmacy employing an on-site Point of Sale (POS) computer system 76 which may comprise any type of computer device such as laptop, handheld or mobile computers, a desktop computer or workstation, etc., having processing and communication capabilities. Associated with the on-site retail pharmacy computer 76 is a printer (not shown) that generates the targeted (smart patient) message 50 including a complementary product coupon(s) 55 comprising a discount for patient customer purchase of a prescription drug companion product.

More specifically, the retail pharmacy computer system 76 includes a processor and includes functionality for operating as or in conjunction with a separate point-of-sale terminal at a local retail pharmacy chain (a pharmacy retail checkout stand). The pharmacy computer 76 communicates information with a “back-end” system located within the store, or remotely with a central data processing system 80, e.g., located at the pharmacy's central office or headquarters. Thus, communications between the retail pharmacy computer 76 and back-end or central data processing system 80 is via a network connection 79 over a communication network 89 which may comprise a Local Area Network (LAN), a Wide Area Network (WAN), a wireless network, a Public Switched Telephone Network (PSTN), or an Internet Protocol (IP) network such as the Internet, a corporate intranet or an extranet, or any other network environment. The retail pharmacy computer 76 is on-site and preferably runs at least one Pentium class processor. A second processor may be provided for redundancy. Moreover, the on-site retail pharmacy computer 76 runs an operating system, such as Microsoft Windows NT 4.0, or like equivalent. Preferably, the on-site retail pharmacy computer 76 also may include a RAID or any similar array for data storage, access speed, and redundancy. As will be described, the on-site retail pharmacy computer 76 receives data entered by the pharmacist including a national drug code (NDC) identifying the patient's prescription drug together with other substantive data relating to the patient including the patient's name and address, the pharmacy, and prescription number.

As further shown in FIG. 2, the retailer back-end or central data processing system 80 comprises a mainframe or high-capacity computer (minicomputer, distributed system, a redundant application server or server cluster) 85 having an Internet protocol (e.g., TCP/IP stack) enabling file transfer (e.g., File Transfer Protocol (FTP)) or HTTP capability. One back-end data processing system may comprise a database server 86 providing database management and adapted to access and store retailer and patient information stored in a retailer datastore comprising the intelligent healthcare repository 25 that serves as the repository for customer profile data and, includes functionality for performing customer profile data processing and customer database management and includes a database, hard disk memory storage, CD-ROM, RAM, or like memory storage means. In one embodiment, compression and encryption systems for authorizing users and securing communications can be provided for all data transfers to/from the retail pharmacy computer 76 so that patient privacy is ensured. For example, virtual private network technology may be utilized to transmit the data between the pharmacy computer 76 and the remote central data processing system 80. Typically, virtual private networks (VPNs) “tunnel” their own protocol and packets within standard Internet IP packets. According to one embodiment, all transfers between the retail pharmacy computer 76 and the central data processing system 80 are via T-1 lines, however, any high-speed transmission link may be substituted for the T-1 line, e.g., a wide band link (e.g., XDSL, frame relay, X.11, cable modem, etc.). Moreover, the data may be transferred via tape transfer, modem or FTP. It should be noted that any of the transfers previously or subsequently described may be via any of those formats or any other known format for transferring data.

As further shown in FIG. 2, the retailer's central data processing system 80 is provided with an executing software program referred to herein as a Product Recommendation Engine (PRE) 90 that processes the transactions initiated at the retail pharmacy POS and handles specific communications between the Retailer back-end data processing systems 80 and product information datastore 35 associated with a supplier 30 that supplies products, e.g., OTC non-prescription healthcare, beauty aids and medical supplies to the retailer. In one embodiment, a product supplier 30 is Johnson & Johnson Inc., through their various operating companies, e.g., Johnson & Johnson Consumer Companies, Inc., McNeil-PPC, Inc. (Consumer and Specialty Pharmaceuticals), Neutrogena, etc. that supplies OTC products to the retail outlet. Specifically, the PRE includes a connector client program 92 that communicates with a corresponding server program 94 resident on one or more computer systems 36 of the OTC product supplier 30 over a network 89 via a local area network, wide area network, VPN, Intranet or Internet connection. The PRE (transaction engine) 90 comprising PRE client and PRE server each have message processing and message routing capabilities according to techniques well known in the art, and include readily available hardware devices and software which enable their use. Optionally, the PRE Server and PRE Connector may both reside on the retailer back-end system as one program. The OTC product supplier computer systems 36 may comprise any mainframe or high-capacity computer (minicomputer, distributed system, or server cluster) having an Internet protocol (e.g., TCP/IP stack) enabling file transfer (e.g., File Transfer Protocol (FTP)) or HTTP capability. One computing device may include a database server 37 executing a database program, such as Microsoft SQL version 6.5 or higher for accessing OTC product data stored in an OTC product supplier datastore 35. It is understood that any database system would suffice implementing techniques for loading OTC product supplier data into and accessing data from the supplier datastore 35.

The software programming code effectuating the PRE transaction engine may be embodied on any of a variety of known media for use with a data processing system, such as a diskette, hard drive, or CD-ROM, or the code may be distributed. The techniques and methods for embodying software programming code in memory, on physical media, and/or distributing software code via networks are well known and will not be further discussed herein.

As further shown in FIG. 2, there is additionally provided supplier client machines 32a, . . . 32,n integrated within the supplier computing system that may comprise one of any number of different types of computer devices that may communicate with the PRE server device 94, e.g., over a network 89 via a wired or wireless Internet or network connection. Wired connections are those that use physical media such as cables and telephone lines, whereas wireless connections use media such as satellite links, radio frequency waves, and infrared waves. It is understood that many connection techniques can be used with these various media, for example, using a cellular modem to establish a wireless connection. Particularly, the supplier's client devices 32a, 32b, . . . , 30n may be any type of computer processor, including laptop, handheld or mobile computers; vehicle-mounted devices; desktop computers; mainframe computers; etc., having processing and communication capabilities.

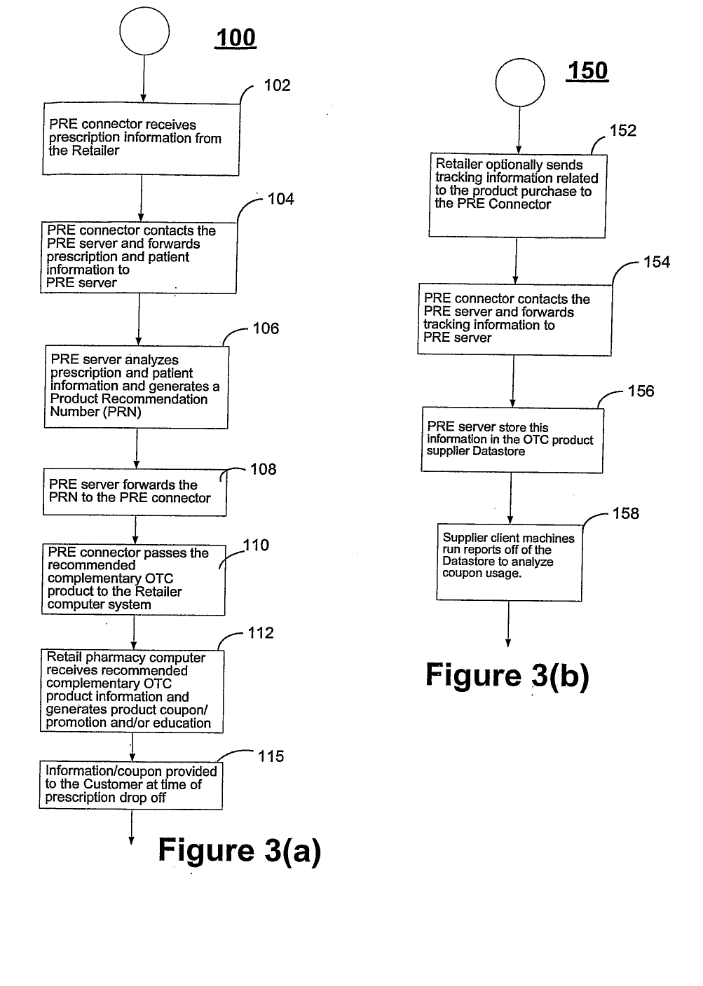

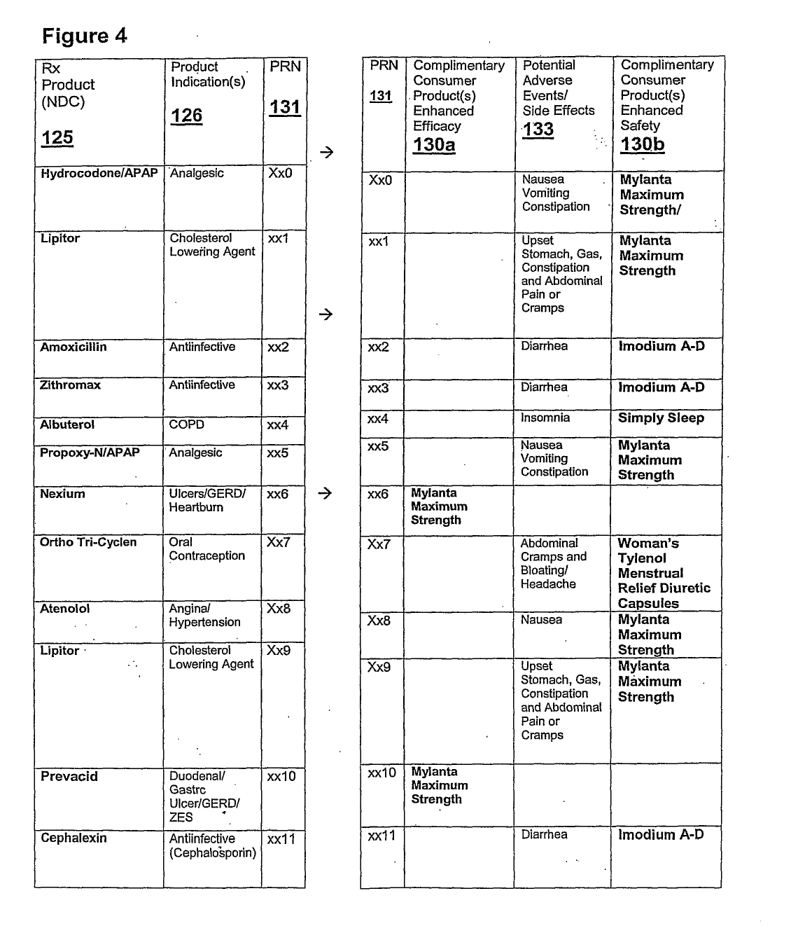

FIG. 3(a) illustrates the data processing 100 performed by the system 10 of the present invention. As shown in FIG. 3, a first step 102 includes the transmission of prescription data and patient information to the retailer central data processing system 80. More specifically, the data provided by the retailer system to the PRE connector 92 includes one or more of the following, including but not limited to: the national drug code (NDC); the patient's name, address, phone number, date of birth (DOB), gender, and weight; insurance information; the pharmacist; the pharmacy filling the prescription; the prescription number; the type of illness; and information about the prescription itself. Prescription information that may be optionally transferred includes: the number of refills prescribed, the number of refills remaining, the refill number, the date the prescription is dispensed, the quantity dispensed, the price of the prescription, the amount the patient is to pay for the prescription, the co-payment amount, etc. This data may be entered manually by the pharmacist at the time of the prescription drop-off or, the prescription may be received by the pharmacy using an Interactive Voice Response or currently implemented “Rapid refill” systems which may be modified using known techniques to incorporate messaging. Once the data is received at the central data processing system 80, the retailer customer database 12 is updated to reflect the transaction and, as indicated at step 104, the executing PRE connector 92 contacts the PRE server 94 and forwards prescription and patient information to the PRE server. Then, at step 106, the PRE server analyzes prescription and patient information and generates a Product Recommendation Number (PRN) that is associated with an OTC complementary product. Optionally, the NDC may additionally be mapped to a specific product number (not shown) associated with a specific supplier brand, e.g., Johnson & Johnson, Inc., McNeil-PPC, Inc. The PRE server specifically uses the NDC to obtain an OTC complementary product from the supplier product data source which may include one or more companion products that ameliorate potential side effects associated with customer's taking of the prescription product, or, that enhance efficacy of a customer's taking of a prescription product. In one embodiment, as shown in FIG. 4, the PRE server 94 operating in conjunction with the product supplier computer systems 36 provides a mechanism for mapping the NDC of the prescription product 125 for an associated indication 126, with an associated corresponding PRN 131. Returning to step 108 in FIG. 3(a), the PRE server then proceeds to forward the PRN 131 (and/or the optional specific OTC product number) to the PRE connector. This number is then mapped to a specific recommended complementary OTC product and potentially, a specific brand, which information is then passed to the Retailer computer system 76 as indicated at step 110. Then, as indicated at step 112, in response to receipt of the product, the retail pharmacy computer 76 generates a smart message including information pertaining to the recommended complementary OTC product providing enhanced patient safety and/or enhanced efficacy. The retailer computer may additionally generate a product coupon 55 and/or like promotion and/or education information associated with the complementary OTC product for the patient in the smart patient message 50 at the time the prescription is handed off. For example, at the retailer's discretion, the retailer may chose to offer a 10% discount off the OTC product, or apply special rebates, e.g., give a “2 for 1” special, etc. In one embodiment, for example, as shown in FIG. 4, the retailer system 80 may generate information and coupons for one or more of the recommended companion OTC products, for example, those indicated in columns 130a, 130b with the associated PRN. For instance, a patient's prescription for the Cholesterol Lowering Agent Lipitor may cause potential adverse events/side effects 133 such as upset stomach, gas, constipation and abdominal pain or cramps and may be mapped to a complementary companion product 130b that ensures safety by providing relief from acid indigestion, sour stomach and heartburn such as Mylanta® Maximum Strength. In another example, a patient's prescription for Nexium which treats effects such as Ulcers/GERD/Heartburn will be mapped to a complementary companion product 130a that enhances the efficacy of the drug such as Mylanta® Maximum Strength. Further examples are shown as provided in the mapping table of FIG. 4, however, it is understood that the complementary OTC products shown and described with respect to FIG. 4 are indicated for illustrative purposes, in a non-limiting way, and it is intended that many other complementary products and brands for the indicated prescription drugs and other prescribed drugs (not shown) may be recommended to the patient in accordance with the invention.

Preferably, the complementary OTC product information is stored locally at the retailer and synchronized down to each store via the network and messaging protocols indicated. As part of a normal synchronization process, the retailer pharmacy computer 76 generates the corresponding coupon or promotion and additionally, provides important product information such as dosing information, for example. Additionally generated for the patient use is education information consistent with the disease being treated which may be displayed on the pharmacist's display terminal and/or printed directly on the coupon or as a separate document at the POS terminal. The smart patient message information may alternately be provided to the patient via fax or e-mail; otherwise, the information is printed for the patient at the POS. For addition, a message may be generated that would indicate to the patient that the OTC product recommended is designed to enhance the efficacy of the accompanying prescription product and/or ameliorate the side effects. Additionally generated for the patient is a message that would let the patient know the anticipated wait time for the prescription to be filled which would encourage the patient to stick around and shop in the pharmacy front-end. That is, means may be implemented for determining a wait time at the pharmacy based upon factors such as: the number of prescriptions that are to be filled and the pharmacist's workload. As a further feature of the invention, additionally generated for the patient is a message indicating whether the prescription drug has been modified to OTC status. For example, a switch of a prescription Cholesterol Lowering product Mevacor® to OTC status. New products or line extensions could be addressed for any OTC product, e.g. if the complimentary brand would be Tylenol, the system would generate a message for the patient indicating that Tylenol “Cool” is the latest line extension. To ensure persistence and compliance, an additional message may be generated for patients to indicate to them to take their prescription product as prescribed and until completely finished.

In an alternate embodiment, it is understood that the operation of the complementary OTC product mapping mechanism depicted in FIG. 4 may be implemented within the pharmacy retail system, e.g., when PRE engine 90 is wholly contained at the retailer back-end.

Returning to FIG. 3(a), at step 115, the information for the complementary OTC product is provided to the customer at time of prescription drop off and any coupon generated is advantageously redeemable at the retail business entity while the patient waits for the prescription to be dispensed. Thus, if the patient desires, he/she may purchase the recommended complementary product while the customer's prescription is being filled. Other pertinent information that may be generated for printing include the number of refills prescribed or remaining, the refill number, the date the prescription was dispensed, the quantity dispensed, the price of the prescription, the amount the patient is to pay for the prescription, the co-payment amount, the number of days supply dispensed, and dosing instructions, etc. It should be understood that event when prescriptions are dialed-in via a “Rapid refill” system, the patients are still alerted that a coupon is available.

FIG. 3(b) illustrates potential processing 150 initiated by the supplier client machines 32a, 32b, . . . , 32n shown in FIG. 2. In this aspect of the invention, as indicated at step 152, the retailer forwards tracking information related to the patient's purchase of a complementary product to the PRE Connector. This tracking information may include the specific product number associated with a specific supplier brand that the NDC was mapped to. First, the Retailer system 80 will update the retailer customer database 12 to reflect the complementary OTC product purchase transaction, and then, in a next step 154, the PRE Connector 92 passes this information to the PRE Server 94. In response, at step 156, the PRE Server 94 will initiate storage of this customer's transaction information the OTC product supplier datastore 35. The supplier client machines 32a, 32b, . . . , 32n may then run reports off of the datastore 35 to analyze coupon usage as shown at step 158. For example, a report may be generated to indicate the percentage of coupons for the specific product redeemed or its price point, i.e., how much the customer paid for the product. It is ensured that information associated with the patients including personal data such as names, addresses and social security numbers are not transmitted or made available to the OTC supplier computer systems. That is, mechanisms for “de-identifying” patients are provided so that information may be efficiently gathered from the databases to allow research and analysis and the generation of reports regarding coupon usage.

Thus, similar to coupons reflecting purchases currently generated by printers at supermarket check out counters, the pharmacy messaging system 10 of the present invention will deliver targeted messages to patients based on their prescription information and one or more of their demographic, healthcare payor, claims, and past purchase history. The overall goal of the Pharmacy Messaging System is to deliver the right message, to the right person, and the right time.

It is understood that it is within the scope of the invention to additionally offer coupons, for other products that may be intended to occupy the customers time while waiting for their prescription to be filled, such as beverages, magazines, food items such as snacks, etc., besides the complementary non-prescription products.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described our invention, what we claim as new, and desire to secure by Letters Patent is:

1. A system for a generating targeted message for customers at a pharmacy, said system comprising:
a retail business entity having a pharmacy adapted for receiving and filling customer prescriptions for products, said retail business entity further adapted to selling over the counter (OTC) products to said customers,
a means for receiving information about a customer's prescription at the time of filling, and associating a complementary OTC product for potential use by said customers; and,
a means for a generating customer targeted message promoting use and/or purchase of said associated complementary OTC products available for purchase at said retail business entity.

2. The system for generating messages as claimed in claim 1, wherein said targeted messages are generated at a point of sale.

3. The system for generating messages as claimed in claim 1, wherein said targeted messages include a discount coupon for encouraging customer purchase of said associated complementary OTC products.

4. The system for generating messages as claimed in claim 3, wherein said associated complementary OTC products include products that ameliorate potential side effects associated with customer's taking of said prescription product.

5. The system for generating messages as claimed in claim 3, wherein said associated complementary OTC products include products that enhance efficacy of a customer's taking of said prescription goods.

6. The system for generating messages as claimed in claim 2, wherein said promotion discount for said associated complementary OTC products are effective for purchase by said customers while said customer prescriptions are being filled at said pharmacy.

7. The system for generating messages as claimed in claim 1, wherein said targeted messages include a rebate for encouraging customer purchase of other OTC products.

8. The system for generating messages as claimed in claim 1, wherein said targeted messages detail how customer may comply with managed care formulary associated with the prescription product being filled.

9. The system for generating messages as claimed in claim 1, wherein said targeted messages provide information directed to new OTC products.

10. The system for generating messages as claimed in claim 1, wherein said targeted messages provide information directed to extensions associated with existing OTC products.

11. A method for providing goods and services to a customer through a retail business entity having a pharmacy adapted for receiving and filling customer prescriptions, and further adapted to supplying non-prescription products for potential purchase by customers, said method comprising steps of:
receiving prescription information for a patient; and,
generating one or more targeted messages deliverable to said patient while waiting for their prescription to be filled at said pharmacy for encouraging customers to purchase said non-prescription products at said retail business.

12. The method for providing goods and services as claimed in claim 11, wherein said targeted messages are generated at a point of sale.

13. The method for providing goods and services as claimed in claim 11, wherein said targeted messages include a discount coupon for encouraging customer purchase of complementary products, said complementary products being sold over the counter (OTC).

14. The method for providing goods and services as claimed in claim 13, wherein said complementary OTC products include companion products that ameliorate potential side effects associated with customer's taking of a prescription product.

15. The method for providing goods and services as claimed in claim 13, wherein said complementary OTC products include companion products that enhance efficacy of a customer's taking of a prescription product.

16. The method for providing goods and services as claimed in claim 13, wherein said promotion discount coupon for said complementary OTC products are redeemable at said retail business entity while said customer prescriptions are being filled.

17. The method for providing goods and services as claimed in claim 11, wherein said targeted messages include a rebate for encouraging customer purchase of other OTC products.

18. The system for providing goods and services as claimed in claim 11, wherein said targeted messages detail how customer may comply with managed care formulary associated with the prescription being filled.

19. The system for providing goods and services as claimed in claim 11, wherein said targeted messages provide information directed to new OTC products.

20. The system for generating messages as claimed in claim 11, wherein said targeted messages provide information directed to extensions associated with existing OTC.

21. A program storage device readable by a machine, tangibly embodying a program of instructions executable by the machine to perform method steps for providing goods and services to a customer through a retail business entity having a pharmacy adapted for receiving and filling customer prescriptions, and further adapted to supplying non-prescription products for potential purchase by customers, said method comprising steps of:
receiving prescription information for a patient; and,
generating one or more targeted messages deliverable to said patient while waiting for their prescription to be filled at said pharmacy for encouraging customers to purchase said non-prescription products at said retail business.

22. The program storage device readable by a machine as claimed in claim 21, wherein said targeted messages include a discount coupon for encouraging customer purchase of complementary products, said complementary products being sold over the counter (OTC).

23. The program storage device readable by a machine as claimed in claim 22, wherein said complementary OTC products include companion products that ameliorate potential side effects associated with customer's taking of a prescription product.

24. The program storage device readable by a machine as claimed in claim 22, wherein said complementary OTC products include companion products that enhance efficacy of a customer's taking of a prescription product.

25. The program storage device readable by a machine as claimed in claim 22, wherein said promotion discount coupon for said complementary OTC products are redeemable at said retail business entity while said customer prescriptions are being filled.

26. The program storage device readable by a machine as claimed in claim 21, wherein said targeted messages include a rebate for encouraging customer purchase of other OTC products.

27. The program storage device readable by a machine as claimed in claim 21, wherein said targeted messages detail how customer may comply with managed care formulary associated with the prescription being filled.

28. The program storage device readable by a machine as claimed in claim 21, wherein said targeted messages provide information directed to new OTC products.

29. The program storage device readable by a machine as claimed in claim 21, wherein said targeted messages provide information directed to extensions associated with existing OTC.

30. A method for a generating targeted message for customers at a pharmacy adapted to filling and dispensing a customer's prescription and having additional non-prescription products available for purchase, said method comprising the steps of:
receiving a customer's prescription for a prescribed product;
forwarding customer's prescription information at the time of filling to a data processing device;
said processing device associating a complementary non-prescription product for potential use by said customers; and,
generating a targeted message for said customer promoting use and/or purchase of said associated complementary non-prescription product available for purchase prior to dispensing said customer's filled prescription.

31. The method as claimed in claim 30, wherein said data processing device is wholly located at said pharmacy.

32. The method as claimed in claim 30, wherein said data processing device is remotely located from said pharmacy, said forwarding customer's prescription step b) comprising communicating said information to a data processing device over a network connection.

33. The method as claimed in claim 32, wherein said data processing device is associated with a supplier of said complementary non-prescription products, said associating step c) further including steps of:
mapping said received prescription information with an identifier associated with said complementary non-prescription product; and,
forwarding said associated identifier of said complementary non-prescription product to said pharmacy for generating said targeted message.

34. The method as claimed in claim 31, wherein said generated targeted message includes a discount coupon for said associated complementary non-prescription product that is redeemable when a customer purchases said associated complementary non-prescription product while waiting said customer's prescription to be filled.

35. The method as claimed in claim 34, further comprising the steps of:
forwarding customer purchase transaction data to a data processing device associated with said supplier of said complementary non-prescription products; and,
enabling generation of reports to analyze discount coupon use for said associated complementary non-prescription product.
